(19) United States
(12) Patent Application Publication
(10) Pub. No.: US 2016/0235507 A1
(43) Pub. Date: Aug. 18, 2016

(54) INTERDENTAL CLEANING APPARATUS USING BOTH HANDS

(71) Applicant: Cheoljae LEE, Yeoncheon-gun (KR)

(72) Inventor: Cheoljae LEE, Yeoncheon-gun (KR)

(21) Appl. No.: 14/942,985

(22) Filed: Nov. 16, 2015

(30) Foreign Application Priority Data
Feb. 16, 2015 (KR) 10-2015-0023609
Nov. 5, 2015 (KR) 10-2015-0155077

(51) Int. Cl. A61C 15/04

(52) U.S. Cl. CPC A61C 15/046

(57) ABSTRACT

The present invention relates to an interdental cleaning apparatus using both hands. The embodiments of the present invention has an effect that is sanitary since a user is able to use dental floss by holding a dental floss supplying stick and a dental floss collecting stick by both hands, the length and tension is available to be easily controlled, different from the conventional dental floss holder of ‘Y’ shape, and various flossing motions are provided by utilizing feeling of the user's hand as it is.

### CROSS REFERENCES

This application claims priority to and the benefit of Korean Patent Application Nos. 10-2015-0023609 and 10-2015-0155077 respectively filed in the Korean Intellectual Property Office on Feb. 16, 2015 and Nov. 5, 2015, the entire contents of which are incorporated herein by reference.

### BACKGROUND OF THE INVENTION

1. Field of the Invention

The present invention relates to an interdental cleaning apparatus using both hands, and more particularly, to an interdental cleaning apparatus using both hands, which supports dental, floss with a dental floss supplying stick and a dental floss collecting stick instead of fingers, wherein the dental floss supplying stick provides unused dental floss and the dental floss collecting stick collects used dental floss, a length of the dental floss supported by being connected to the dental floss supplying stick and the dental floss collecting stick is controllable, such that a user is able to care teeth with various flossing motions as well as to control the tension of dental floss easily by utilizing feeling of the user's hand as it is.

2. Discussion of the Related Art

Dental floss, a sort of oral care products, has a thin thread shape, and is a tool for caring portions between teeth intensively where it is hard to care with a tooth brush only. The dental floss has no side effects of opening teeth, which is different from using a toothpick, and enables to remove plague between teeth efficiently, and accordingly, it helps to prevent dental calculus.

An interdental brush, another sort of oral care products, is designed to remove food remains or dental calculus formed in a triangle zone between two teeth and gum, but the dental floss is designed to remove food remains or dental calculus between teeth.

In addition, the interdental brush itself must be cleaned for repetitive use. However, the dental floss is cut as much as it is needed whenever it is used and discarded after using, it is portable and convenient to be used regardless of place.

Commonly, the dental floss is contained in a case considering sanitation, and therefore, it is easy to carry, except for disposable one. The dental floss is designed to be used by being cut as much as it is needed or by being tied to a holder.

Such a conventional case for dental floss is just a case to contain dental floss, and a user extracts dental floss contained in the case and cuts it with a cutter attached to the case, then use it.

When the user uses the dental floss cut from the case by winding the dental floss on fingers, it is available to adjust tension of the dental floss by utilizing feeling of hands. Accordingly, there is a merit of effectively caring teeth by adjusting a length of the dental floss in various angle positions.

However, when using the conventional case for dental floss, there is inconvenience that a user should extract and cut dental floss with a suitable length, and use the dental floss by winding it on both fingers every time, further, there is a drawback of inducing pain on fingers since tension is exerted to the dental floss winded on the fingers when cleaning teeth with tension being maintained after passing through the dental floss between teeth.

In addition, a user should cut dental floss longer than actual length required in order to fix it by winding on fingers, and so it causes a problem that dental floss is wasted more than needs. Further, in case that a user uses dental floss from loosening what is winded on fingers in order to adjust length of the dental floss, it also causes sanitary problems.

Moreover, there is a case that a user inserts fingers where the dental floss is winded to use the dental floss, which causes displeasure such as inducing vomiting as well as the sanitary problems.

As another conventional case of dental floss, a dental floss holder of ‘Y’ shape has been used. This works in a way that the dental floss is fixed on two pillars spaced apart at an upper part of main body in which the dental floss is contained.

However, this type of case has a problem that a user has to unwind dental floss and re-fix the dental floss since the dental floss fixed on two pillars tends to be loosen, as well as there is an inconvenience of fixing dental floss on two pillars every time.

In addition, there are inconveniences that it is not allowed to adjust a length of dental floss since the distance between two pillars is fixed, and the two pillars pierce inside of mouth when the dental floss holder is deeply inserted into mouth.

Accordingly, the present invention is to overcome the problems, and has an object to provide an interdental cleaning apparatus using both hands, which is sanitary since a user is able to use dental floss by holding a dental floss supplying stick and a dental floss collecting stick by both hands, enables the length and tension to be easily controlled, different from the conventional dental floss holder of ‘Y’ shape, and provides various flossing motions by utilizing feeling of the user's hand as it is.

In addition, an object of the present invention is to provide an interdental cleaning apparatus using both hands, which can solve the problem of inconvenience that a user should cut dental floss and use it by winding it on both fingers every time or a user should use dental floss by winding on a separate dental floss holder and discard it by cutting, since clean dental floss is continuously supplied from dental floss bundle contained in the dental floss supplying stick and used dental floss is stored in the dental floss collecting stick or discarded after being extracted outside, and which can minimize the waste of the dental floss

Furthermore, an object of the present invention is to provide an interdental cleaning apparatus using both hands where dental care products are equipped since separate storage space is provided in the dental floss supplying stick and/or the dental floss collecting stick, and interdental brushes, an oral refresher spray, a vibrator unit. etc. can be stored in the storage space.

The object of the present invention is not limited thereto, but the other objects not mentioned herein can be clearly understood from the description below for an ordinary stilled person in this an.

### SUMMARY OF THE INVENTION

According to an embodiment of the present invention to attain the objects, an interdental cleaning apparatus using both hands is provided. The apparatus includes a dental floss supplying stick including a dental floss storing space where dental floss is stored, an open mg for extracting the dental floss stored in the dental floss strong space, and a dental floss fixing means that controls movement of the dental floss; and a dental floss collecting stick separately provided from the dental floss supplying stick and including a returnable dental floss fixing means, wherein the dental floss is respectively fixed at the dental floss fixing means of the dental floss supplying stick and the returnable dental floss fixing means of the dental floss collecting stick.

The embodiments of the present invention has an effect that is sanitary since a user is able to use dental floss by holding a dental floss supplying stick and a dental floss collecting stick by both hands, the length and tension is available to be easily controlled, different from the conventional dental floss holder of ‘Y’ shape, and various flossing motions are provided by utilizing feeling of the user's hand as it is.

In addition, the embodiments of the present invention has an effect that can solve the problem of inconvenience that a user should cut dental floss and use it by winding it on both fingers every time or a user should use dental floss by winding on a separate dental floss holder and discard it by cutting, since clean dental floss is continuously supplied from dental floss bundle contained in the dental floss supplying stick and used dental floss is stored in the dental floss collecting stick or discarded after being extracted outside.

Furthermore, the embodiments of the present invention has an effect of being stored and used together with dental care products since a separate storage space is provided in the dental floss supplying stick and/or the dental floss collecting stick, and interdental brushes, an oral refresher spray, a vibrator unit, etc. can be stored in the storage space.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a perspective view illustrating an interdental cleaning apparatus using both hands according to a first embodiment of the present invention.

FIG. 2 is an exploded perspective view illustrating a first embodiment of a dental floss supplying stick that is applicable to the interdental cleaning apparatus shown in FIG. 1.

FIG. 3 is a sectional view illustrating an engagement of the dental floss supplying stick shown in FIG. 2.

FIG. 4 is a drawing illustrating an operation process of the dental floss supplying stick shown in FIG. 2.

FIG. 5 is an exploded perspective view illustrating a second embodiment of a dental floss supplying stick that is applicable to the interdental cleaning apparatus shown in FIG. 1.

FIG. 6 is a drawing illustrating an operation process of according to a first modified embodiment of the dental floss supplying stick shown in FIG. 2.

FIG. 7 is a partial sectional view illustrating a second modified embodiment of the dental floss supplying stick shown in FIG. 2.

FIG. 8 is an exploded perspective view illustrating a first embodiment of a dental floss collecting stick that is applicable to the interdental cleaning apparatus shown in FIG. 1.

FIG. 9 is a sectional view illustrating an engagement of the dental floss collecting stick shown in FIG. 8.

FIG. 10 is an exploded perspective view illustrating a second embodiment of a dental floss collecting stick that is applicable to the interdental cleaning apparatus shown in FIG. 1.

FIG. 11 is a perspective view illustrating an interdental cleaning apparatus using both hands according to a second embodiment of the present invention.

FIG. 12 is an exploded perspective view illustrating a first embodiment of a dental floss collecting stick that is applicable to the interdental cleaning apparatus shown in FIG. 11.

FIG. 13 is a sectional view illustrating an engagement of a part of the dental floss collecting stick shown in FIG. 12.

FIG. 14 is an exploded perspective view illustrating a second embodiment of a dental floss collecting stick that is applicable to the interdental cleaning apparatus shown in FIG. 11.

FIG. 15 is a perspective view illustrating an example of use of a vibration unit shown in FIG. 14.

FIG. 16 is an exploded perspective view illustrating a third embodiment of a dental floss collecting stick that is applicable to the interdental cleaning apparatus shown in FIG. 11.

FIG. 17 is a perspective view illustrating an interdental cleaning apparatus using both hands according to the third embodiment of the present invention.

FIG. 18 is an exploded perspective view illustrating a first embodiment of a dental floss supplying stick that is applicable to the interdental cleaning apparatus shown in FIG. 17.

FIG. 19 is an exploded perspective view illustrating a first embodiment of a dental floss collecting stick that is applicable to the interdental cleaning apparatus shown in FIG. 17.

FIG. 20 is a drawing illustrating an operation process of the dental floss collecting stick shown in FIG. 19.

FIG. 21 is an exploded perspective view illustrating a second embodiment of a dental floss collecting stick that is applicable to the interdental cleaning apparatus shown in FIG. 17.

FIG. 22 is a drawing illustrating an operation process of the dental floss collecting stick shown in FIG. 21.

FIG. 23 is an exploded perspective view illustrating an interdental cleaning apparatus using both hands and a storage case according to the embodiments of the present invention.

FIG. 24 is a partially exploded perspective view illustrating an interdental cleaning apparatus using both hands according to the fourth embodiment of the present invention.

FIG. 25 is a drawing illustrating an operation process of the dental floss collecting stick that is applicable to the interdental cleaning apparatus shown in FIG. 24.

FIG. 26 is a perspective view illustrating a stored state of the interdental cleaning apparatus shown in FIG. 25.

### DETAILED DESCRIPTION OF THE INVENTION

Hereinafter, the embodiments of the present invention will be described in detail with reference to the accompanying drawings. It should be understood that in the drawings, when adding reference numerals to elements in each drawing, the same elements are denoted by the same reference numerals although the elements are shown in different drawing if it is possible.

In addition, in describing the present invention, if it is determined that detailed description for related known elements or functions makes the purport of the present invention obscure, the detailed description will be omitted.

Further, terms such as “a first”, “a second”, “A”, “B”, “(a)”, “(b)”, etc. may be used for describing elements of the present invention. Such terms are only designated to distinguish an element from another element, but the nature or order of the corresponding terms is not limited to the terms.

When it is described that an element is “connected” or “coupled” to another element, it should be understood that the element may be directly connected or coupled, but the other element may be “connected” or “coupled” between each of the elements.

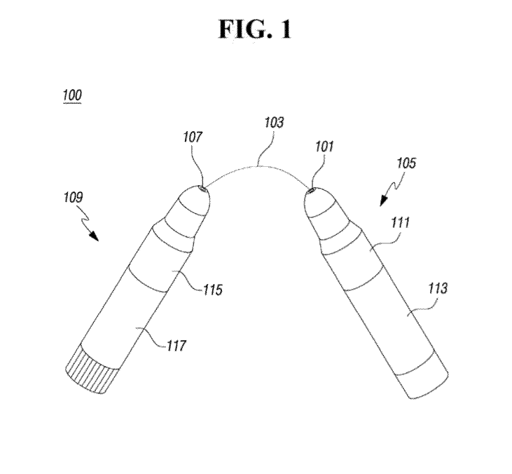

Hereinafter, by reference to FIG. 1 to FIG. 10, an interdental cleaning apparatus using both hands according to a first embodiment of the present invention will be described.

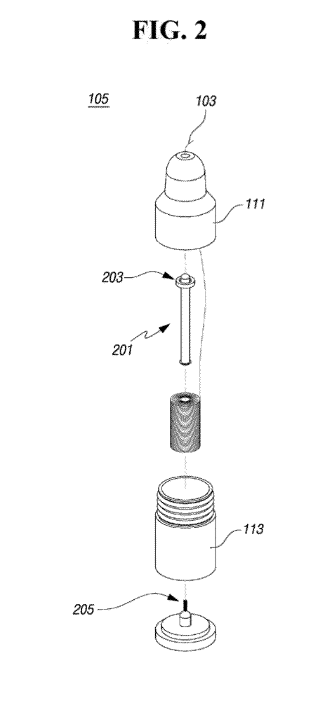

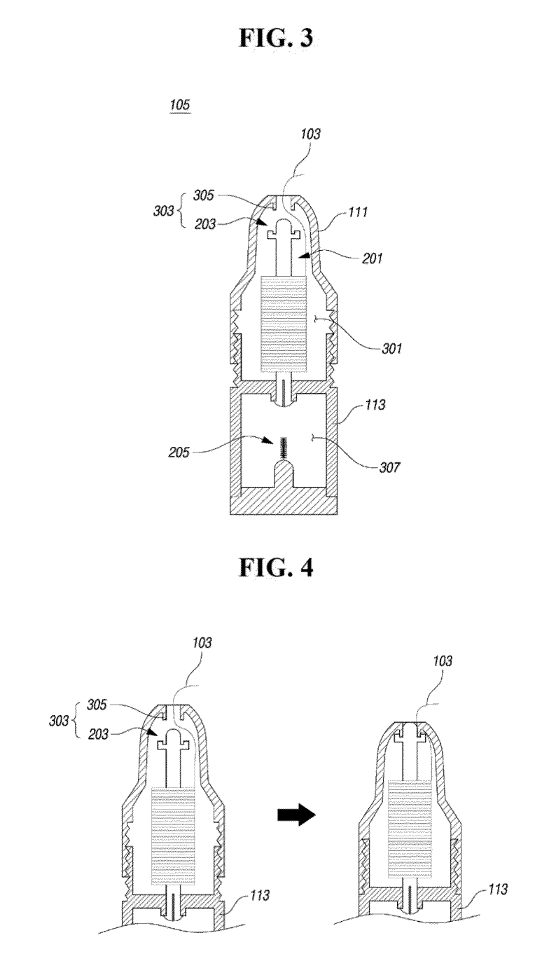

FIG. 1 is a perspective view illustrating an interdental cleaning apparatus using both hands according to the first embodiment of the present invention. FIG. 2 is an exploded perspective view illustrating a first embodiment of a dental floss supplying stick that is applicable to the interdental cleaning apparatus shown in FIG. 1. FIG. 3 is a sectional view illustrating an engagement of the dental floss supplying stick shown in FIG. 2.

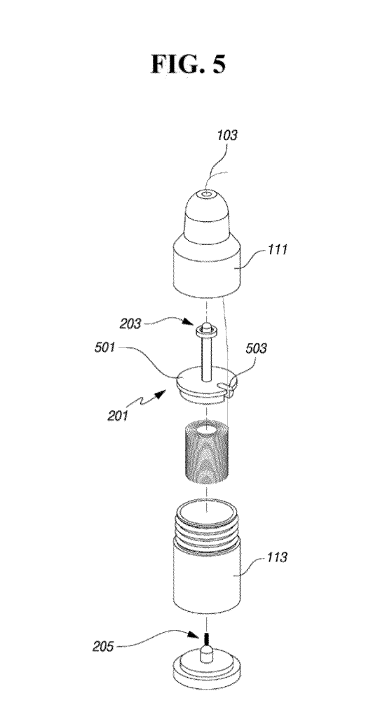

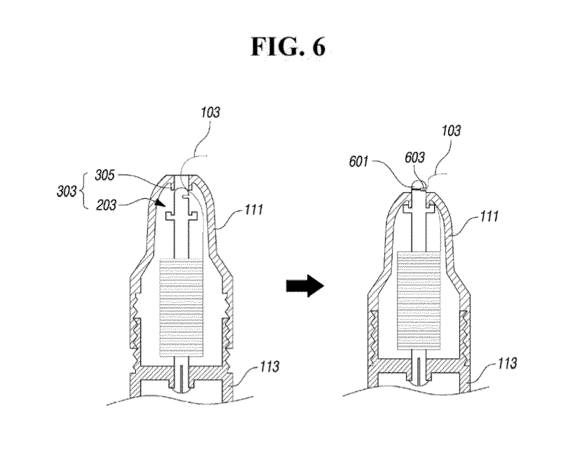

FIG. 4 is a drawing illustrating an operation process of the dental floss supplying stick shown in FIG. 2. FIG. 5 is an exploded perspective view illustrating a second embodiment of a dental floss supplying stick that is applicable to the interdental cleaning apparatus shown in FIG. 1. FIG. 6 is a drawing illustrating an operation process of according to a first modified embodiment of the dental floss supplying stick shown in FIG. 2.

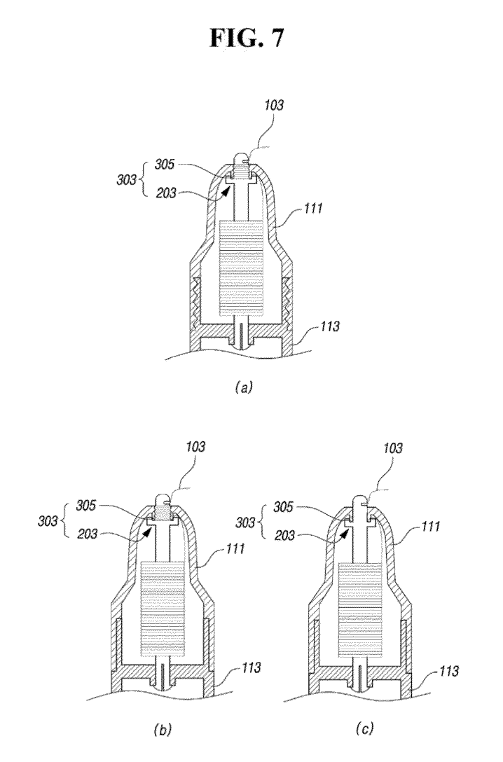

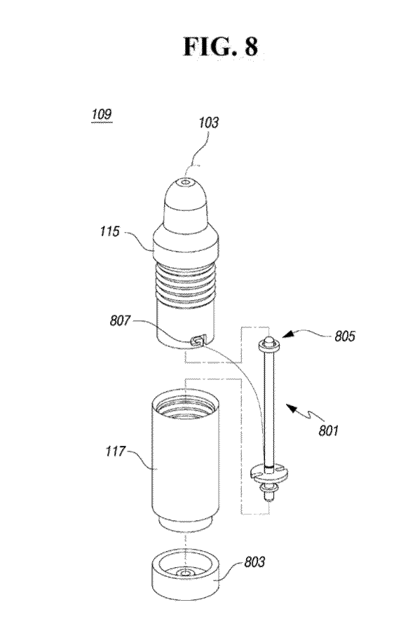

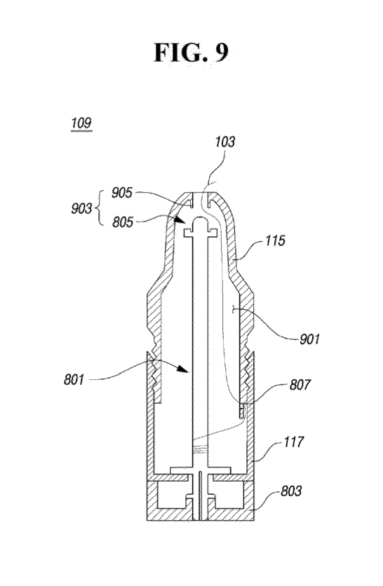

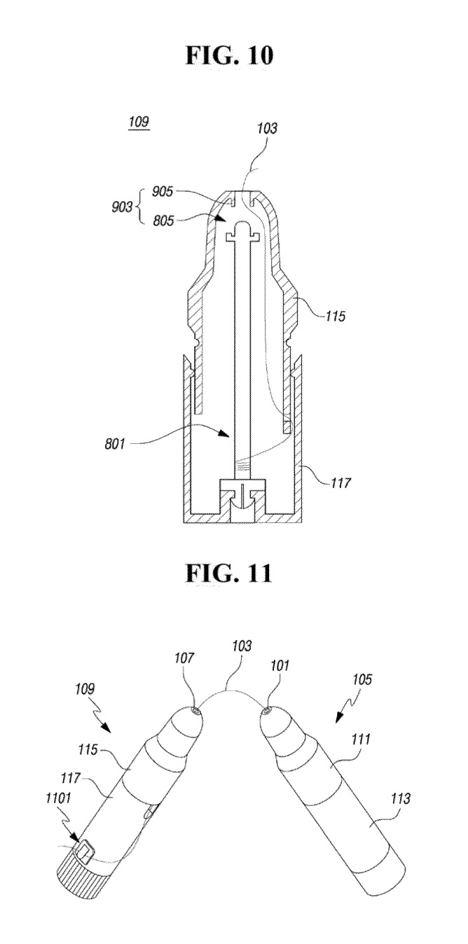

FIG. 7 is a partial sectional view illustrating a second modified embodiment of the dental floss supplying stick shown in FIG. 2. FIG. 8 is an exploded perspective view illustrating a first embodiment of a dental floss collecting stick that is applicable to the interdental cleaning apparatus shown in FIG. 1. FIG. 9 is a sectional view illustrating an engagement of the dental floss collecting stick shown in FIG. 8. FIG. 10 is an exploded perspective view illustrating a second embodiment of a dental floss collecting stick that is applicable to the interdental cleaning apparatus shown in FIG. 1.

As shown in the drawings above, an interdental cleaning apparatus 100 using both hands according to a first embodiment of the present invention includes a dental floss supplying stick 105 including an opening 101 for extracting dental floss, a dental floss storing space 301 where dental floss 103 is stored and a dental floss fixing means 303 that controls movement of the dental floss 103; and a dental floss collecting stick 109, which is physically separately provided from the dental floss supplying stick (preferably, perfectly physically separately provided), and including an opening 107 for inserting returnable dental floss and a returnable dental floss fixing means 903 for controlling movement of the dental floss 103 therein, wherein the dental floss 103 stored in the dental floss storing space is respectively fixed at the dental floss fixing means of the dental floss supplying stick and the returnable dental floss fixing means of the dental floss collecting stick, and used dental floss is stored in the dental floss collecting stick 109 via the opening 107 for inserting returnable dental floss.

Hereinafter, the dental floss supplying stick 105 and the dental floss collecting stick 109 will be described sequentially.

The dental floss supplying stick 105 performs a function of supplying the dental floss 103. At an upper part of the dental floss supplying stick 105, the opening 101 for extracting dental floss is formed to extract the dental floss 103, and inside of the dental floss supplying stick 105, the dental floss storing space 301 where the dental floss (dental floss bundle) 103 is stored is provided.

In addition, the dental floss fixing means 303 for controlling movement of the dental floss 103 is provided inside of the dental floss supplying stick 105.

Such a dental floss supplying stick 105 may be provided in a long rod shape so as to be held by one hand.

Meanwhile, in describing an example of a structure of the dental floss supplying stick 105 in more detail, the dental floss supplying stick 105 may include a dental floss supply-side upper case 111 and a dental floss supply-side lower case 113, which are engaged with or released from each other.

Here, the dental floss supply-side upper case 111 and the dental floss supply-side lower case 113 may be engaged with or released from each other with a engaging means such as a screw thread engaging means, a tight fit engaging means, etc., and beside, may be engaged with or released from each other with various engaging means.

Of course, different from this, the dental floss supplying stick 105 may form a stick shape in which a plurality of covers is integrally coupled in upper and lower direction or left and right direction.

At an upper part of the dental floss supply-side upper case 111, the opening 101 for extracting dental floss is formed, and a lower part of the dental floss supply-side upper case 111 is formed with an opening shape.

Accordingly, when the dental floss supply-side upper case 111 is engaged with the dental floss supply-side lower case 113, the dental floss storing space 301 where the dental floss (dental floss bundle) 103 is stored is formed, and a dental floss movement route where the dental floss 103 supply moves is formed.

Here, the dental floss movement route signifies a passage through which the dental floss 103 moves toward the opening 101 for extracting dental floss, and a passage where the dental floss 103 supply (i.e., unused dental floss) is not exposed to outside.

The dental floss supply-side lower case 113 is engaged with or released from the dental floss supply-side upper case 111, and a dental floss supply-side inner pillar 201, which is inserted into the dental floss supply-side upper case 111 and guides movement of the dental floss 103 stored in the dental floss storing space 301, is provided in the dental floss supply-side lower case 113.

At the moment, the dental floss supply-side inner pillar 201 may be provided in a shape of being extended from the dental floss supply-side lower case 113 to the upper part, as shown in FIG. 3, or extended with being protruded from the center to the upper part after being engaged at an upper end of the dental floss supply-side lower case 113 with a cap shape, as shown in FIG. 5.

Of course, in case of the dental floss supply-side inner pillar 201 shown in FIG. 5, a dental floss passing groove 503 of a grooved shape may be formed on a body part 501 which is supported at the upper end of the dental floss supply-side lower case 113.

Meanwhile, as an example, the dental floss fixing means 303 that controls movement of the dental floss 103 may include a first upper case dental floss fixing part 305 formed at an inner circumference of the dental floss supply-side upper case 111 and a first inner pillar dental floss fixing part 203 which is engaged with or released from the first upper case dental floss fixing part 305 and formed at an outer circumference surface of the dental floss supply-side inner pillar 201.

Here, the first upper case dental floss fixing part 305 and the first inner pillar dental floss fixing part 203 may be formed in an uneven structure that is engaged with each other, and owing to the uneven structure, the first upper case dental floss fixing part 305 and the first inner pillar dental floss fixing part 203 may be firmly and tightly coupled with each other, and accordingly, available to fix the dental floss 103.

In addition, when the first upper case dental floss fixing part 305 and the first inner pillar dental floss fixing part 203 are coupled, an upper end of the first inner pillar dental floss fixing part 203 (i.e., an upper end of the dental floss supply-side inner pillar 201) is inserted into and seals the opening 101 for extracting dental floss, which prevents foreign substances from penetrating into the dental floss supplying stick 105.

And the upper end of the first inner pillar dental floss fixing part 203 (i.e., an upper end of the dental floss supply-side inner pillar 201) may be protruded outside of the dental floss supply-side upper case 111 when the first upper case dental floss fixing part 305 and the first inner pillar dental floss fixing part 203 are coupled. A groove 603, which is laterally inserted as shown in FIG. 6, is formed at an outer circumference of the protruded part 601, and accordingly, when a user uses it, the dental floss 103 which is extracted from the dental floss supplying stick 105 is winded in the groove 603, and then, a length of it may be adjusted.

Of course, a protrusion may be formed at an outer circumference of the opening 101 for extracting dental floss, instead of the groove 603, and the dental floss 103 placed between the dental floss supplying stick 105 and the dental floss collecting stick. 109 is winded, and then, a length of it may be adjusted.

In addition, the dental floss fixing means 303 described above may replace or assist the function of a engaging means (a screw thread engaging means or a tight fit engaging means) that the dental floss supply-side upper case 111 and the dental floss supply-side lower case 113 may be engaged with or released from.

That is, when either one of the engaging means or the dental floss fixing means 303 that engages or releases the dental floss supply-side upper case 111 and the dental floss supply-side lower case 113 is strongly engaged or loosely engaged, or release the engagement, the rest of them is also strongly engaged or loosely engaged, or release the engagement, which is interconnected thereto.

Also, even if the dental floss fixing means 303 is released, the dental floss supply-side upper case 111 and the dental floss supply-side lower case 113 are prevented from being completely separated by maintaining loose engagement.

In other words, the engaging means and the dental floss fixing means 303 that engages or releases the dental floss supply-side upper case 111 and the dental floss supply-side lower case 113 engage or release with a screw thread engaging way or a tight fit engaging way, respectively, as shown in FIG. 7. By interconnecting the operation, when the engaging means is released or switched from a strong engagement to a loosen engagement, then the coupling force of the dental floss fixing means 303 may be released or switched to a loose engagement.

Accordingly, the dental floss 103 provided in the dental floss storing space 301 may be extracted outside through the opening 101 for extracting dental floss since the movement of the dental floss 103 is free. And when the engaging means is strongly engaged again, the dental floss fixing means 303 is also strongly engaged, then, the dental floss 103 is firmly fixed to the dental floss supplying stick 105.

Or, in case that the dental floss fixing means 303 is a screw thread engaging type, since the dental floss 103 is fixed by the dental floss fixing means 303 and simultaneously, the dental floss supply-side upper case 111 and the dental floss supply-side lower case 113 are also coupled, separate engaging means may not required.

Meanwhile, FIG. 7 (a) illustrates an example that the engaging means and the floss supply fixing means 303 are a screw thread engaging type. FIG. 7 (b) illustrates an example that the engaging means is a tight fit engaging type and the floss supply fixing means 303 is a screw thread engaging type, and FIG. 7(c) illustrates an example that the engaging means is a tight fit engaging type and the floss supply fixing means 303 is also a tight fit engaging type.

Further, a storage space 307 may be provided at a lower part of the dental floss supplying stick 105. In the storage space 307, an interdental brush 205 may be stored in order to increase user's convenience.

The dental floss collecting stick 109 performs the role of collecting the dental floss 103. The opening 107 for inserting returnable dental floss is formed at the upper part of the dental floss collecting stick 109 so as to insert the dental floss 103, and a returnable dental floss storing space 901 where a returnable dental floss (dental floss bundle) 103 for collecting the dental floss 103 may be provided inside of the dental floss collecting stick 109.

In addition, the returnable dental floss fixing means 903 that controls movement of the dental floss 103 is provided inside of the dental floss collecting stick 109.

Such a dental floss collecting stick 109 may be provided in a long rod shape such that a user easily holds it with one hand.

Meanwhile, when describing an example of a structure of the dental floss collecting stick 109 in more detail, the dental floss collecting stick 109 may include a dental floss collecting-side upper case 115 and a dental floss collecting-side lower case 117 which are engaged with or released from each other.

Here, the dental floss collecting-side upper case 115 and the dental floss collecting-side lower case 117 may be engaged with or released from each other with a engaging means such as a screw thread engaging means, a tight fit engaging means, etc., and beside, may be engaged with or released from each other with various engaging means.

Of course, different from this, the dental floss collecting stick 109 may form a stick shape in which a plurality of covers is integrally coupled in upper and lower direction or left and right direction.

The opening 107 for inserting returnable dental floss is formed at an upper part of the dental floss collecting-side upper case 115, and a lower part of the dental floss collecting-side upper case 115 is formed with an opening shape.

Accordingly, when the dental floss collecting-side upper case 115 is engaged with the dental floss collecting-side lower case 117, the returnable dental floss storing space 901 where the dental floss (dental floss bundle) 103 is stored may be formed, and a dental floss movement route where the returnable dental floss 103 moves is formed.

Here, the dental floss movement route where the returnable dental floss 103 moves signifies a passage through which the dental floss 103 inserted through opening 107 for inserting returnable dental floss moves, and a passage where the returnable dental floss 103 (i.e., used dental floss) is not exposed to outside.

The dental floss collecting-side lower case 117 is engaged with or released from the dental floss collecting-side upper case 115, and a dental floss collecting-side inner pillar 801, which is inserted into the dental floss collecting-side upper case 115 and guides movement of the dental floss 103 inserted through opening 107 for inserting returnable dental floss, is provided in the dental floss collecting-side lower case 117.

At the moment, the dental floss collecting-side inner pillar 801 may be provided with a structure that a lower end that passes through a lower surface of the dental floss collecting-side lower case 117 is coupled to a peg knob 803, as shown in FIG. 9, or may be provided with a structure that a lower end of the dental floss collecting-side inner pillar 801 is coupled to the lower surface of the dental floss collecting-side lower case 117, as shown in FIG. 10.

Here, in case that the lower end of the dental floss collecting-side inner pillar 801 is coupled to the peg knob 803 through the lower surface of the dental floss collecting-side lower case 117, when the dental floss collecting-side upper case 115 and the dental floss collecting-side lower case 117 engage in order to fix the dental floss 103 after the dental floss is collected with being winded on the dental floss collecting-side inner pillar 801, the problem that is hard to adjust a length of the dental floss 103 since the dental floss collecting-side lower case 117 excessively rotates can be solved.

And a dental floss inducing groove 807 for inducing the collected dental floss 103 to the dental floss collecting-side inner pillar 801 may be formed on any one side or both sides that the dental floss collecting-side upper case 115 and the dental floss collecting-side lower case 117 face each other. In the drawings, an example is shown that the dental floss inducing groove 807 is formed on the dental floss collecting-side upper case 115, particularly.

As such, since the dental floss inducing groove 807 is formed, the collecting dental floss 103 is not influenced by the rotation of the dental floss collecting-side lower case 117 or the peg knob 803, and can be winded on the dental floss collecting-side inner pillar 801 without being entangled.

Meanwhile, the returnable dental floss fixing means 903 that controls movement of the dental floss 103 may include, for example, a second upper case dental floss fixing part 905 formed on an inner circumference of the dental floss collecting-side upper case 115, and a second inner pillar dental floss fixing part 805 formed on an outer circumference of the dental floss collecting-side inner pillar 801 engaged with or released from the second upper case dental floss fixing part 905.

Here, the second upper case dental floss fixing part 905 and the second inner pillar dental floss fixing part 805 may be formed in an uneven structure that is engaged with each other, and owing to the uneven structure, the first upper case dental floss fixing part 305 and the second inner pillar dental floss fixing part 805 may be firmly and tightly coupled with each other, and accordingly, available to fix the dental floss 103.

In addition, when the second upper case dental floss fixing part 905 and the second inner pillar dental floss fixing part 805 are coupled, an upper end of the second inner pillar dental floss fixing part 805 (i.e., an upper end of the dental floss collecting-side inner pillar 801) is inserted into and seals the opening 107 for inserting returnable dental floss, which prevents foreign substances from penetrating into the dental floss collecting stick 109.

And, although it is not depicted in the drawings, similar to the structure shown in FIG. 6, the upper end of the second inner pillar dental floss fixing part 805 (i.e., an upper end of the dental floss collecting-side inner pillar 801) may be protruded outside of the dental floss collecting-side upper case 115 when the second upper case dental floss fixing part 905 and the second inner pillar dental floss fixing part 805 are coupled. A groove which is laterally inserted is formed at an outer circumference of the protruded part, and accordingly, when a user uses it, the dental floss 103 which is inserted into the dental floss collecting stick 109 is winded in the groove, and then, a length of it may be adjusted.

Of course, a protrusion may be formed at an outer circumference of the opening 107 for inserting returnable dental floss, instead of the groove, and the dental floss 103 placed between the dental floss collecting stick 109 and the dental floss supplying stick 105 is winded, and then, a length of it may be adjusted.

In addition, the returnable dental floss fixing means 903 described above may replace or assist the function of a engaging means (a screw thread engaging means or a tight fit engaging means) that the dental floss collecting-side upper case 115 and the dental floss collecting-side lower case 117 may be engaged with or released from.

That is, when either one of the engaging means or the returnable dental floss fixing means 903 that engages or releases the dental floss collecting-side upper case 115 and the dental floss collecting-side lower case 117 is strongly engaged or loosely engaged, or release the engagement, the rest of them is also strongly engaged or loosely engaged, or release the engagement, which is interconnected thereto.

Also, even if the returnable dental floss fixing means 903 is released, the dental floss collecting-side upper case 115 and the dental floss collecting-side lower case 117 are prevented from being completely separated by maintaining loose engagement.

In other words, the engaging means and the returnable dental floss fixing means 903 that engages or releases the dental floss collecting-side upper case 115 and the dental floss collecting-side lower case 117 engage or release with a screw thread engaging way or a tight fit engaging way, respectively. By interconnecting the operation, when the engaging means is released or switched from a strong engagement to a loosen engagement, then the coupling force of the returnable dental floss fixing means 903 may be released or switched to a loose engagement. Accordingly, movement of the dental floss 103 is free, and the dental floss 103 may be inserted into the returnable dental floss storing space 901 through the opening 107 for inserting returnable dental floss.

And when the engaging means is strongly engaged, the returnable dental floss fixing means 903 is also strongly engaged, then, the dental floss 103 is firmly fixed to the dental floss collecting stick 109.

Or, in case that the returnable dental floss fixing means 903 is a screw thread engaging type, since the dental floss 103 is fixed by the returnable dental floss fixing means 903 and simultaneously, the dental floss collecting-side upper case 115 and the dental floss collecting-side lower case 117 are also coupled, separate engaging means may not required.

Hereinafter, by reference to FIG. 11 to FIG. 16, an interdental cleaning apparatus using both hands according to a second embodiment of the present invention will be described.

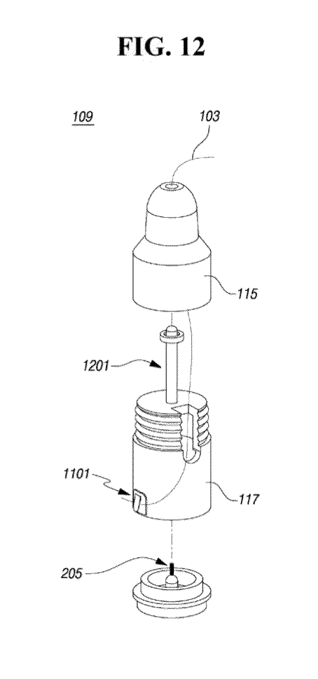

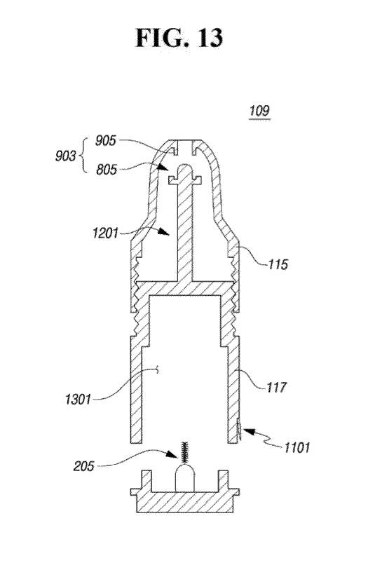

FIG. 11 is a perspective view illustrating an interdental cleaning apparatus using both hands according to the second embodiment of the present invention. FIG. 12 is an exploded perspective view illustrating a first embodiment of a dental floss collecting stick that is applicable to the interdental cleaning apparatus shown in FIG. 11. FIG. 13 is a sectional view illustrating an engagement of a part of the dental floss collecting stick shown in FIG. 12.

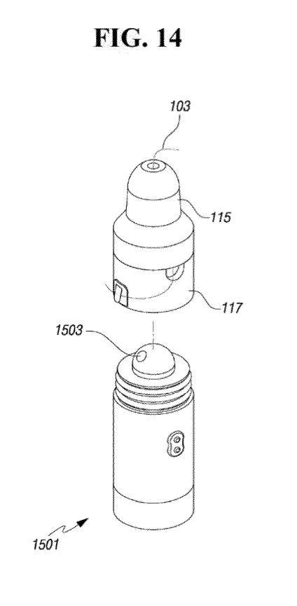

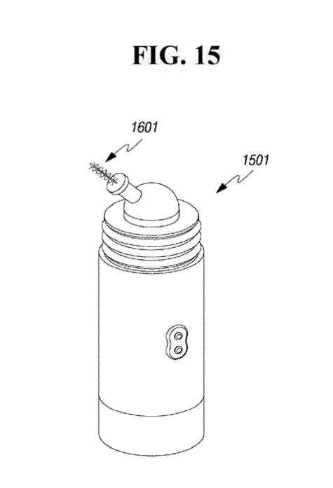

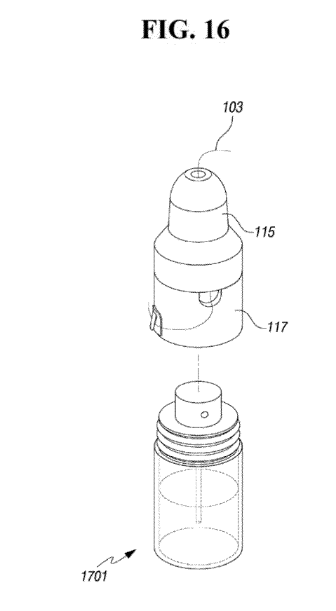

FIG. 14 is an exploded perspective view illustrating a second embodiment of a dental floss collecting stick that is applicable to the interdental cleaning apparatus shown in FIG. 11. FIG. 15 is a perspective view illustrating an example of use of a vibration unit shown in FIG. 14. FIG. 16 is an exploded perspective view illustrating a third embodiment of a dental floss collecting stick that is applicable to the interdental cleaning apparatus shown in FIG. 11.

While the interdental cleaning apparatus according to the first embodiment described above shown in FIG. 1 to FIG. 10 has the structure that the returnable dental floss 103 (i.e. used dental floss) is stored in the returnable dental floss storing space provided inside of the dental floss collecting stick, the interdental cleaning apparatus according to the second embodiment has a structure that the returnable dental floss is not stored in the dental floss collecting stick, but is removed.

As shown in FIG. 11 to FIG. 16, an interdental cleaning apparatus 100 using both hands according to a second embodiment of the present invention includes a dental floss supplying stick 105 which is applied to the first embodiment described above; and a dental floss collecting stick 109 including an opening 107 for inserting returnable dental floss and a returnable dental floss fixing means 903 for controlling movement of the dental floss 103 therein.

As mentioned above, since the dental floss supplying stick 105 is identical to the dental floss supplying stick according to the first embodiment described above, only the dental floss collecting stick 109 will be described below.

A denial floss collecting-side inner pillar 1201 is provided with a structure that an upper portion is extended with being protruded from an upper surface of the dental floss collecting-side lower case 117 to an upper part, and a cutting part 1101 that cut the returnable dental floss 103 (i.e., used dental floss) is provided on an outer surface of the dental floss collecting stick 109, for example, an outer surface of the dental floss collecting-side lower case 117.

And, in the dental floss collecting-side lower case 117, an incision part is formed to extract the dental floss inserted into the dental floss collecting-side upper case 115 toward outside of the dental floss collecting stick 109.

Accordingly, the returnable dental floss 103 (i.e., used dental floss) may be simply cut by using the cutting part 1101 in a state of being extracted outside of the dental floss collecting stick through the incision art which is formed in the dental floss collecting-side lower case 117.

In addition, a storage space 1301 may be provided at a lower part of the dental floss collecting stick 109, and the interdental brush 205 may be stored in the storage space 1301. On the other hand, an oral refresher spray 1701 or a vibrator unit 1501, etc. may be connected or stored in the dental floss collecting-side lower case 117, and a groove 1503 that may mount the interdental brush 1601 may be formed in the vibrator unit 1501.

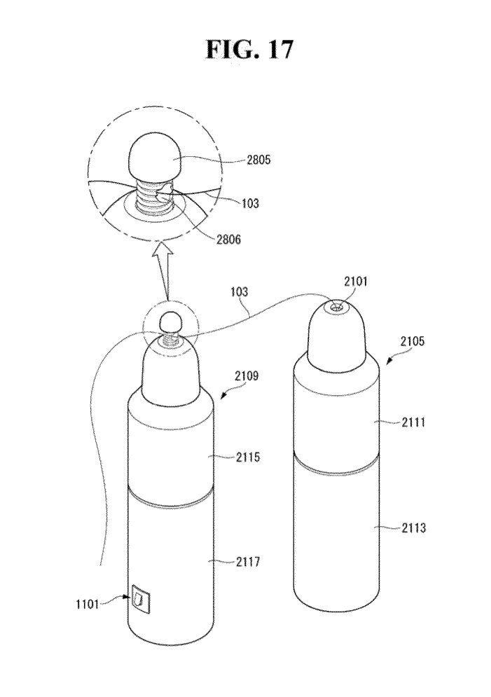

Hereinafter, by reference to FIG. 17 to FIG. 22, an interdental cleaning apparatus using both hands according to a third embodiment of the present invention will be described.

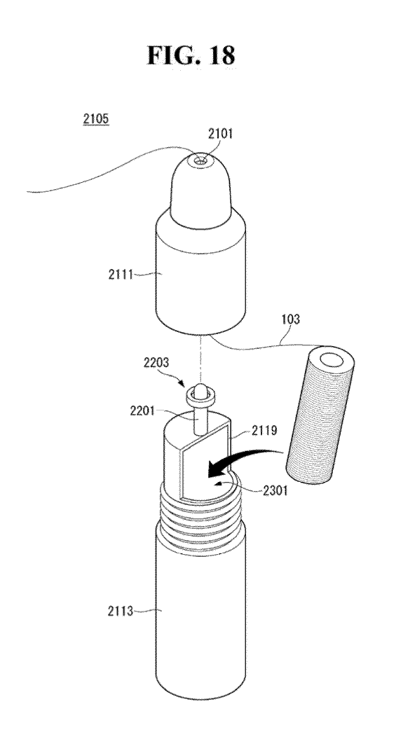

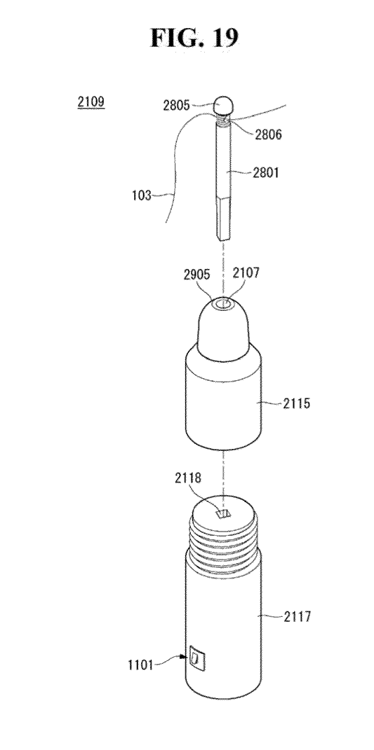

FIG. 17 is a perspective view illustrating an interdental cleaning apparatus using both hands according to the third embodiment of the present invention. FIG. 18 is an exploded perspective view illustrating a first embodiment of a dental floss supplying stick that is applicable to the interdental cleaning apparatus shown in FIG. 17. FIG. 19 is art exploded perspective view illustrating a first embodiment of a dental floss collecting stick that is applicable to the interdental cleaning apparatus shown in FIG. 17.

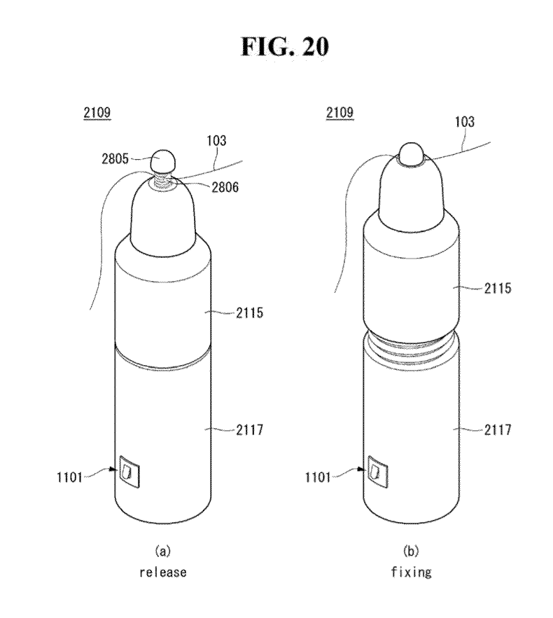

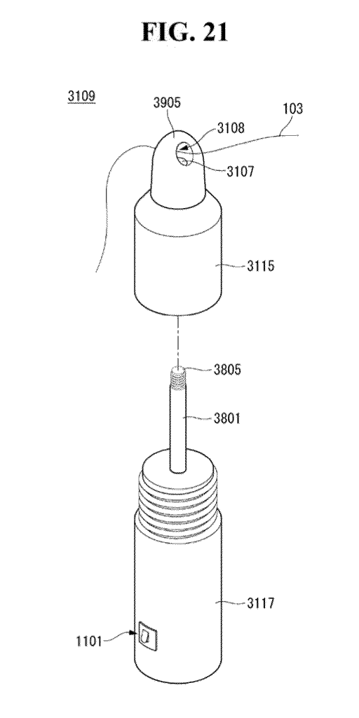

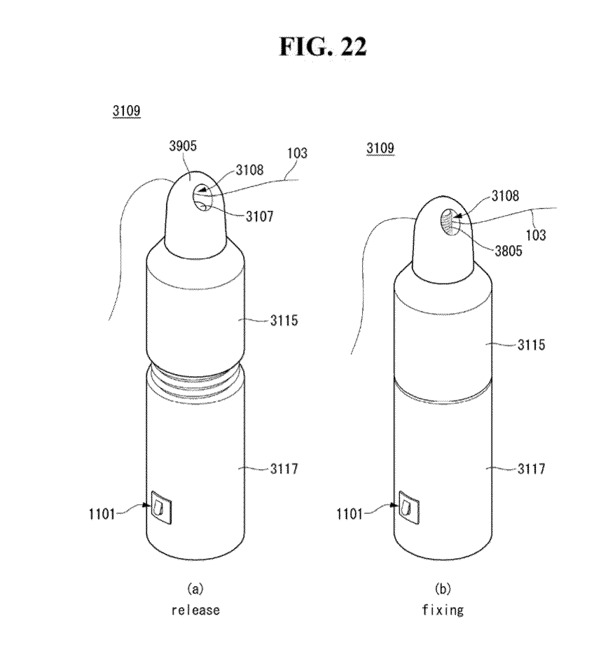

FIG. 20 is a drawing illustrating an operation process of the dental floss collecting stick shown in FIG. 19. FIG. 21 is an exploded perspective view illustrating a second embodiment of a dental floss collecting stick that is applicable to the interdental cleaning apparatus shown in FIG. 17. FIG. 22 is a drawing illustrating an operation process of the dental floss collecting stick shown in FIG. 21.

The interdental cleaning apparatus shown in FIG. 17 to FIG. 22 is constructed such that the returnable dental floss (i.e., used dental floss) is not collected or stored in an inner space of the dental floss collecting stick, but is removed, similar to the second embodiment described above.

First, referring to FIG. 17 to FIG. 20, an interdental cleaning apparatus using both hands according to a third embodiment of the present invention includes a dental floss supplying stick 2105 and a dental floss collecting stick 2109.

The dental floss supplying stick 2105 is provided with a dental floss supply-side upper case 2111 and a dental floss supply-side lower case 2113 that may be engaged with or released from each other with various engaging means such as a screw thread engaging means, a tight fit engaging means, etc.

An opening 2101 for extracting dental floss is formed at an upper part of the dental floss supply-side upper case 2111, and a dental floss storing space 2301 where the dental floss (dental floss bundle) 2103 is stored is provided in the dental floss collecting-side lower case 2113.

And an incision part 2119 is provided in the dental floss collecting-side lower case 2113 so as to extract the dental floss 103 through the opening 2101 for extracting dental floss as well as store the dental floss 103 supply in the dental floss storing space 2301. Adjacent to incision part 2119, a dental floss supply-side inner pillar 2201 that includes a first inner pillar dental floss fixing part 2203 that controls movement of the dental floss 2103 is provided.

Accordingly, when the dental floss collecting-side upper case 2111 is coupled with the dental floss collecting-side lower case 2113, the inner pillar 2201 is located inside of the dental floss supply-side upper case 2111.

Meanwhile, although it is not shown, on an inner circumference of the dental floss supply-side upper case 2111, a first upper case dental floss fixing part (refer to reference numeral 303 in FIG. 3) that is engaged with or released from a first inner pillar dental floss fixing part 2203 formed on the dental floss supply-side inner pillar 2201 may be further formed.

Since the operation of fixing and releasing dental floss by the first inner pillar dental floss fixing part 2203 and the first upper case dental floss fixing part is the same or similar to the first embodiment described above, detailed description will be omitted.

The dental floss collecting stick 2109 includes a dental floss collecting-side upper case 2115 and a dental floss collecting-side lower case 2117 that may be engaged with or released from each other with various engaging means such as a screw thread engaging means, a tight fit engaging means, etc.

Since an opening 2107 is formed at an upper part of the dental floss collecting-side upper case 2115 and a lower part of the dental floss collecting-side upper case 2115 is formed with an open shape, when the dental floss collecting-side upper case 2115 is coupled to the dental floss collecting-side lower case 2117, a dental floss collecting-side inner pillar 2801 is located therein.

The dental floss collecting-side inner pillar 2801 is coupled to the dental floss collecting-side lower case 2117. In order to properly maintain the coupling state of the dental floss collecting-side inner pillar 2801 and the dental floss collecting-side lower case 2117, a groove 2118 where a lower end of the dental floss collecting-side inner pillar 2801 is coupled is formed in a polygon shape, for example, a quadrangle.

Meanwhile, the returnable dental floss fixing means that controls movement of the dental floss 103 may include, for example, a second upper case dental floss fixing part 2905 formed on an outer circumference of the dental floss collecting-side upper case 2115, and a second inner pillar dental floss fixing part 2805 which is engaged with or released from the second upper case dental floss fixing part 2905 and formed on the dental floss collecting-side inner pillar 2801.

And a dental floss hole 2806 is formed on the second inner pillar dental floss fixing part 2805, and a cutting part 1101 that cut the returnable dental floss (i.e., used dental floss) is provided on an outer surface of the dental floss collecting stick 2109, for example, an outer surface of the dental floss collecting-side lower case 2117.

Accordingly, the returnable dental floss (i.e., used dental floss) may be easily cut by using the cutting part 1101.

Hereinafter, by reference to FIG. 21 and FIG. 22, a dental floss collecting stick according to a second embodiment that is applicable to the interdental cleaning apparatus shown in FIG. 17 will be described.

The dental floss collecting stick 3109 according to the embodiment includes a dental floss collecting-side upper case 3115 and a dental floss collecting-side lower case 3117 that may be engaged with or released from each other with various engaging means such as a screw thread engaging means, a tight fit engaging means, etc.

Since a longitudinal opening 3107 and a lateral opening 3108 are formed at an upper part of the dental floss collecting-side upper case 3115 and a lower part of the dental floss collecting-side upper case 3115 is formed with an open shape, when the denial floss collecting-side upper case 3115 is coupled to the dental floss collecting-side lower case 3117, a dental floss collecting-side inner pillar 3801 is located therein.

The dental floss collecting-side inner pillar 3801 is integrally formed with the dental floss collecting-side lower case 3117.

Meanwhile, the returnable dental floss fixing means that controls movement of the dental floss 103 may include, for example, a second upper case dental floss fixing part 3905 formed on the dental floss collecting-side upper case 3115, and a second inner pillar dental floss fixing part 3805 which is engaged with or released from the second upper case dental floss fixing part 3905 and formed on the dental floss collecting-side inner pillar 3801.

And a cutting part 1101 that cut the returnable dental floss (i.e., used dental floss) is provided on an outer surface of the dental floss collecting stick 3109, for example, an outer surface of the dental floss collecting-side lower case 3117.

Accordingly, the returnable dental floss (i.e., used dental floss) may be easily cut by using the cutting part 1101.

The dental floss supplying stick that is applicable to the interdental cleaning apparatus according to the third embodiment may be applied instead of the dental floss supplying stick of the interdental cleaning apparatus according to the first embodiment and the second embodiment described above, and the dental floss collecting stick that is applicable to the interdental cleaning apparatus according to the third embodiment may be applied instead of the dental floss collecting stick of the interdental cleaning apparatus according to the first embodiment and the second embodiment described above.

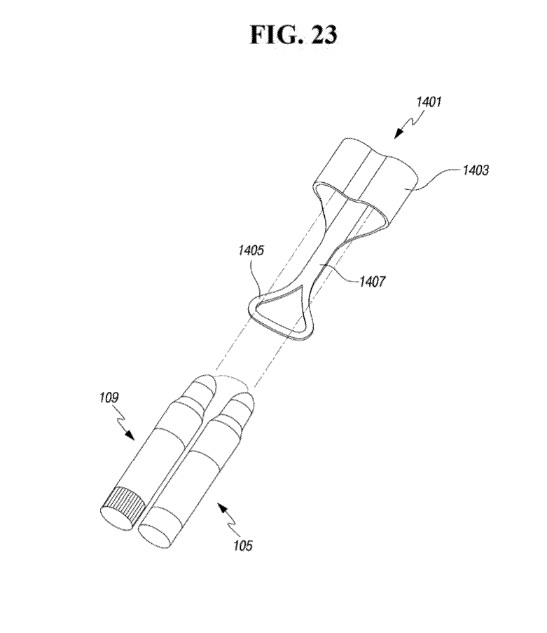

Meanwhile, as shown in FIG. 23, the dental floss supplying stick 105 and 2105 and the dental floss collecting stick 109, 2109 and 3109 may be stored by being received in a storage case 1401, and the storage case 1401 may include a body part 1403 where the dental floss supplying stick 105 and 2105 and the dental floss collecting stick 109, 2109 and 3109 are engaged with tight fit; and a handle part 1407 extendedly formed from the body part 1403, and a tongue cleaner 1405 is formed at an end part.

Here, the tongue cleaner 1405 may be formed in ‘T’ shape or ‘O’ shape, and a scraping part which is protruded in a lateral direction with a predetermined height may be formed.

Such a storage case 1401 enables to use the tongue cleaner 1405 independently as well as to store the dental floss supplying stick 105 and 2105, the dental floss collecting stick 109, 2109 and 3109 and the exposed dental floss 103 simultaneously and hygienically, and accordingly, more efficient dental care becomes available.

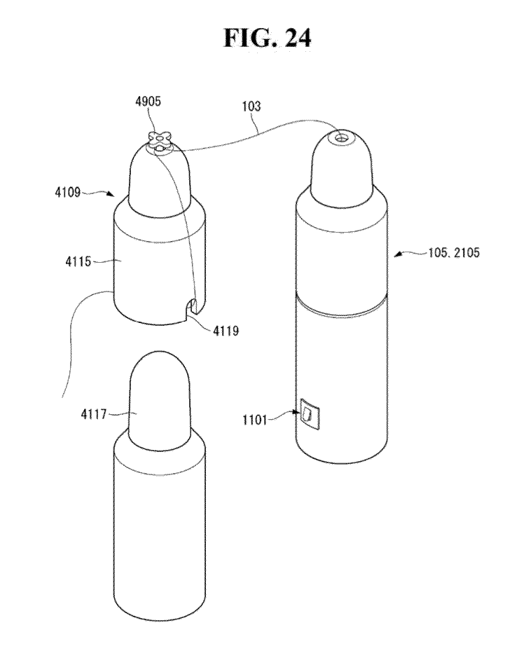

Hereinafter, by reference to FIG. 24 to FIG. 26, an interdental cleaning apparatus using both hands according to a fourth embodiment of the present invention will be described.

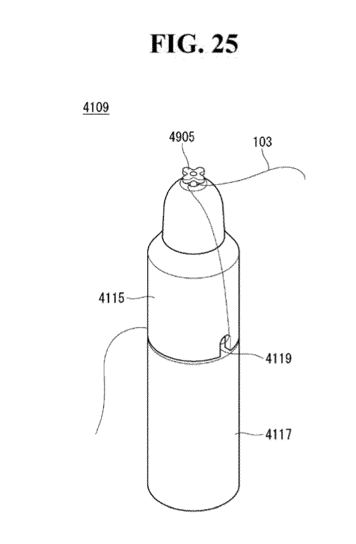

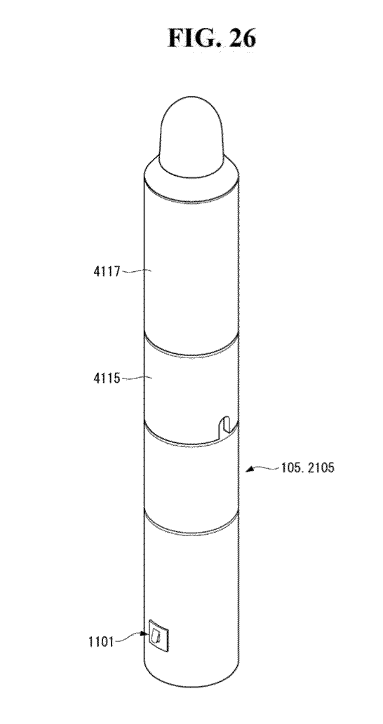

FIG. 24 is a partially exploded perspective view illustrating an interdental cleaning apparatus using both hands according to the fourth embodiment of the present invention FIG. 25 is a drawing illustrating an operation process of the dental floss collecting stick that is applicable to the interdental cleaning apparatus shown in FIG. 24. FIG. 26 is a perspective view illustrating a stored state of the interdental cleaning apparatus shown in FIG. 25.

The interdental cleaning apparatus according to the embodiment has a structure that the returnable dental floss (i.e., used dental floss) is not stored in an inner space of the dental floss collecting stick, but is removed, similar to the interdental cleaning apparatus according to the second embodiment described above.

The interdental cleaning apparatus according to the third embodiment includes a dental floss supplying stick 105 which is applied to the interdental cleaning apparatus according to the first embodiment or a dental floss supplying stick 2105 which is applied to the interdental cleaning apparatus according to the second embodiment, and a dental floss collecting stick 4109 of a new structure.

The dental floss collecting stick 4109 includes a dental floss collecting-side upper case 4115 and a dental floss collecting-side lower case 4117 that may be engaged with or released from each other with a tight fit engaging means.

Since a lower part of the dental floss collecting-side upper case 4115 is formed with an open shape, when the dental floss collecting-side upper case 4115 is coupled to the dental floss collecting-side lower case 4117, a part of the dental floss collecting-side lower case 4117 is located therein.

The returnable dental floss fixing means that controls movement of the dental floss 4103 may include, for example, a second upper case dental floss fixing part 4905 and an incision part 4119 respectively formed on the dental floss collecting-side upper case 4115.

Accordingly, when the dental floss collecting-side lower case 4117 is engaged with the dental floss collecting-side upper case 4115 in a state that a part of the dental floss is located at the incision part 4119 after the dental floss is winded on the second upper case dental floss fixing part 4905 once or twice, the dental floss 4103 is fixed.

When the interdental cleaning apparatus having such a construction is not used, the apparatus may be stored by assembling the dental floss collecting-side upper case 4115 to the dental floss supplying stick 105 or 2105 and assembling the dental floss collecting-side lower case 4117 to the dental floss collecting-side upper case 4115.

And a cutting part 1101 that cut the returnable dental floss (i.e., used dental floss) may be provided on an outer surface of the dental floss supplying stick 105 or 2105.

The embodiments of the present invention having such structures and shapes has an effect that is sanitary since a user is able to use dental floss by holding a dental floss supplying stick and a dental floss collecting stick by both hands, the length and tension is available to be easily controlled, different from the conventional dental floss holder of ‘Y’ shape, and various flossing motions are provided by utilizing feeling of the user's hand as it is.

In addition, the embodiments of the present invention has an effect that can solve the problem of inconvenience that a user should cut dental floss and use it by winding it on both fingers every time or a user should use dental floss by winding on a separate dental floss holder and discard it by cutting, since clean dental floss is continuously supplied from dental floss bundle contained in the dental floss supplying stick and used dental floss is stored in the dental floss collecting stick or discarded after being extracted outside.

Furthermore the embodiments of the present invention has an effect of being stored and used together with dental care products since a separate storage space is provided in the dental floss supplying stick and/or the dental floss collecting stick, and interdental brushes, an oral refresher spray, a vibrator unit, etc. can be stored in the storage space.

So far, the description that all elements that construct the embodiments of the present invention are combined into one or operated by being combined into one does not signify that the present invention is limited to the embodiments.

That is, within the object of the present invention, all of the elements may be operated by being selectively combined into one or more constructions.

In addition, the term, “include”, “construct”, “have”, etc. described so far signifies that the corresponding element may be included, unless otherwise described. Accordingly, the term should be interpreted inclusively, not exclusively.

Generally used terms including technical or scientific terms used herein have the same meaning as commonly understood by one of ordinary skill in the art to which the present invention belongs, unless otherwise defined.

It will be further understood that the terms such as those defined in commonly used dictionary should be interpreted as having a meaning that is consistent with their meaning in the context of the relevant art, and will not be interpreted in an idealized or overly formal sense unless expressly so defined herein.

So far, the description of the present invention has been exemplary presented, many modifications and variations may be made by those of ordinary skill in the art without departing from the spirit and scope of the present invention.

Accordingly, the embodiments disclosed in the present invention are not intended to limit the inventive concept of the present invention, but rather to describe the invention, and the inventive concept is not limited by the embodiments.

The scope of the present invention should be interpreted by the claims below, and it should be interpreted that all inventive concepts which are equivalent to it falls into the scope of the present invention.

What is claimed is:

1. An interdental cleaning apparatus, comprising:
a dental floss supplying stick including a dental floss storing space storing dental floss, an opening for extracting the dental floss from the dental floss strong space, and a dental floss fixing means controlling movement of the dental floss; and
a dental floss collecting stick separately provided from the dental floss supplying stick and including a returnable dental floss fixing means, wherein the dental floss is fixed to the dental floss fixing means of the dental floss supplying stick and the returnable dental floss fixing means of the dental floss collecting stick.

2. The interdental cleaning apparatus of claim 1, wherein the dental floss is stored in the dental floss collecting stick or removed at an outside of the dental floss collecting stick.

3. The interdental cleaning apparatus of claim 2, wherein the dental floss supplying stick includes:
a dental floss supply-side upper case including the opening for extracting the dental floss; and
a dental floss supply-side lower case engaged with or released from the dental floss supply-side upper case, the dental floss supply-side lower case including a dental floss supply-side inner pillar, inserted into the dental floss supply-side upper case and guiding movement of the dental floss stored in the dental floss storing space.

4. The interdental cleaning apparatus of claim 3, wherein, the dental floss fixing means includes:
a first upper case dental floss fixing part formed on an inner circumference surface of the dental floss supply-side upper case; and
a first inner pillar dental floss fixing part engaged with or released from the first upper case dental floss fixing part and formed on an outer circumference surface of the dental floss supply-side inner pillar.

5. The interdental cleaning apparatus of claim 4, wherein the first upper case dental floss fixing part and the first inner pillar dental floss fixing part, respectively, have uneven structures engaged with each other.

6. The interdental cleaning apparatus of claim 2, wherein the dental floss supplying stick includes:
a dental floss supply-side upper case including the opening for extracting the dental floss; and
a dental floss supply-side lower case engaged with or released from the dental floss supply-side upper case, the dental floss supply-side lower case including an incision part for forming the dental floss storing space and a dental floss supply-side inner pillar inserted into the dental floss supply-side upper case.

7. The interdental cleaning apparatus of claim 6, wherein the dental floss fixing means includes:
a first upper case dental floss fixing part formed on an inner circumference surface of the dental floss supply-side upper case; and
a first inner pillar dental floss fixing part engaged with or released from the first upper case dental floss fixing part and formed on an outer circumference surface of the dental floss supply-side inner pillar.

8. The interdental cleaning apparatus of claim 7, wherein the first upper case dental floss fixing part and the first inner pillar dental floss fixing part, respectively, have uneven structures engaged with each other.

9. The interdental cleaning apparatus of claim 2, wherein the dental floss collecting stick includes:
a dental floss collecting-side upper case including an opening for inserting the dental floss; and
a dental floss collecting-side lower case engaged with or released from the dental floss collecting-side upper case, the dental floss collecting-side lower case including a dental floss collecting-side inner pillar inserted into the dental floss collecting-side upper case and guiding movement of the dental floss inserted through the opening for inserting the dental floss.

10. The interdental cleaning apparatus of claim 9, wherein the returnable dental floss fixing means includes:
a second upper case dental floss fixing part formed on an inner circumference surface of the dental floss collecting-side upper case; and
a second inner pillar dental floss fixing part formed on an outer circumference surface of the dental floss collecting-side inner pillar and engaged with or released from the second upper case dental floss fixing part.

11. The interdental cleaning apparatus of claim 10, wherein the second upper case dental floss fixing part and the second inner pillar dental floss fixing part, respectively, have uneven structures engaged with each other.

12. The interdental cleaning apparatus of claim 9, wherein a dental floss inducing groove for guiding the dental floss to the dental floss collecting-side inner pillar is formed in a side surface or two opposite side surfaces of the dental floss collecting-side upper case.

13. The interdental cleaning apparatus of claim 9, wherein the dental floss collecting stick further includes a peg knob rotatably provided at a lower part of the dental floss collecting-side lower case and coupled with a lower end of the dental floss collecting-side inner pillar.

14. The interdental cleaning apparatus of claim 2, wherein the dental floss collecting stick includes:
a dental floss collecting-side inner pillar including a dental floss hole and a second inner pillar dental floss fixing part;
a dental floss collecting-side lower case including a groove for a coupling with the dental floss collecting-side inner pillar; and
a denial floss collecting-side upper case coupled with the dental floss collecting-side lower case and accommodating the dental floss collecting-side inner pillar, the dental floss collecting-side upper case including a second upper case dental floss fixing part engaged with or released from the second inner pillar dental floss fixing part, wherein a cutting part is located at the dental floss collecting-side lower case or the dental floss collecting-side upper case.

15. The interdental cleaning apparatus of claim 2, wherein the dental floss collecting stick includes:
a dental floss collecting-side lower case including a dental floss collecting-side inner pillar including a second inner pillar dental floss fixing part; and
a dental floss collecting-side upper case coupled with the dental floss collecting-side lower case, the dental floss collecting-side upper case including a second upper case dental floss fixing part engaged with or released from the second inner pillar dental floss fixing part, wherein a cutting part is located at the dental floss collecting-side lower case or the dental floss collecting-side upper case.

16. The interdental cleaning apparatus of claim 2, wherein the dental floss collecting stick includes:
a dental floss collecting-side upper case including a second upper case dental floss fixing part and an incision part; and
a dental floss collecting-side lower case coupled with the dental floss collecting-side upper case to fix the dental floss located at the incision part.

17. The interdental cleaning apparatus of claim 2, wherein the dental floss collecting-side upper case is coupled with the dental floss supplying stick to cover the opening for extracting the dental floss of the dental floss supplying stick, and the dental floss collecting-side lower case is coupled with the dental floss collecting-side upper case to cover the second upper case dental floss fixing part.

18. The interdental cleaning apparatus of claim 2, wherein a storage space is positioned in at least one of the dental floss supplying stick or the dental floss collecting stick to receive at least one of an interdental brush, an oral refresher spray, or a vibrator unit.

19. The interdental cleaning apparatus of claim 2, wherein a cutting part is provided at the dental floss collecting stick or the dental floss supplying stick to remove the dental floss outside of the dental floss collecting stick.

20. The interdental cleaning apparatus of claim 2, wherein the dental floss supplying stick and the dental floss collecting stick are detachably fitted into a storage case, and wherein a tongue cleaner is provided at an end of a handle part of the storage case.
